(19) United States
(12) Patent Application Publication
(10) Pub. No.: US 2026/0285218 A1
(43) Pub. Date: Sep. 24, 2026

(54) LABOR-SAVING RATCHET STRAP TENSIONER

(71) Applicant: NINGBO ANHONG AUTO PARTS CO., LTD, Yinzhou (CN)

(72) Inventor: An XU, Yinzhou (CN)

(73) Assignee: NINGBO ANHONG AUTO PARTS CO., LTD, Yinzhou (CN)

(21) Appl. No.: 19/222,778

(22) Filed: May 29, 2025

(30) Foreign Application Priority Data
Mar. 18, 2025 (CN) 202520475489.1

(51) Int. Cl. B60P 7/08

(52) U.S. Cl. CPC B60P 7/083

(57) ABSTRACT

A labor-saving ratchet strap tensioner is provided, including a base, a base plate, a cocking handle, a cocking member, a ratchet, a clamping member, a stopping member, a coil spring, and the like. A brake pad is mainly disposed in the base, and elastically presses a ratchet disc of the ratchet to form braking force. An arc edge is disposed at a bottom portion of a cocking plate. When the stopping member and the clamping member are both separated from the ratchet disc, the ratchet can overcome the braking force to form a reverse rotation and to quickly release a tensioning strap, and the reverse rotation of the ratchet also synchronously drives the coil spring to compress and to accumulate potential energy. Then the cocking handle is cocked close to the base, so that the arc edge can be driven to slide to push the brake pad, thereby adjusting the braking force.

### CROSS REFERENCE TO RELATED APPLICATION

The disclosure claims priority to Chinese Patent Application No. 202520475489.1 filed on Mar. 18, 2025, the disclosure of which is incorporated by reference herein in their entirety.

### TECHNICAL FIELD

The present disclosure relates to a ratchet strap tensioner, and specifically, to a labor-saving ratchet strap tensioner.

### BACKGROUND

At present, a ratchet strap tensioner is applied to cargo binding. A structure of the ratchet strap tensioner mainly includes a base, a base plate in front of the base, a cocking handle, a cocking plate in front of the cocking handle, a ratchet, and the like, and further includes a fastening strap connected to the base, and a tensioning strap with one end wound around a ratchet shaft and the other end being a free binding end. In addition, a clamping member and a coil spring for automatic strap winding are disposed in the base, a stopping member is disposed in the cocking handle, the cocking handle is hingedly connected to the base plate of the base by using the cocking plate, to form a rotatable connection that is capable of being cocked, and the ratchet and the cocking shaft axis are coaxially and rotatably installed. In this way, when both the stopping member and the clamping member are meshed with the ratchet, as long as the cocking handle is reciprocatively cocked relative to the base, the ratchet can be driven, through alternating meshing of the stopping member and the clamping member, to rotate intermittently in one way, to wind the tensioning strap. Alternatively, both the stopping member and the clamping member are separated from the ratchet, and the ratchet is in a free rotation state and can quickly release the tensioning strap or automatically rewind a released tensioning strap onto the ratchet through the coil spring to form fast strap winding. In addition, to prevent safety hazards caused by winding the strap too quickly by the coil spring, a brake pad is often designed in the base. The brake pad is usually elastically pressed on the wound tensioning strap, to form braking force by virtue of contact friction force between the brake pad and the tensioning strap. However, a magnitude of the braking force is often easily affected by a thickness of the wound strap, that is, a thinner wound strap leads to smaller braking force, and a thicker wound strap leads to greater braking force. In other words, the braking force of the brake pad cannot continuously remain stable in a process of winding the strap. For example, in actual use, when the wound strap is very thin, the braking force applied by the brake pad on the wound strap is very small. In this case, potential energy accumulated by compression of the coil spring is highest. Therefore, the braking force on the tensioning strap in this state is less than the potential energy of the coil spring. In this case, when the tensioning strap is completely pulled out from the ratchet, because the potential energy of the coil spring is greater than the braking force, it is difficult for the brake pad to brake and lock a longest use position to which the tensioning strap is pulled. In addition, the brake pad is driven to separate from the wound strap to release the braking force mainly by using buttons or dial keys additionally designed on the base. In actual use, a user needs to use one hand to cock the cocking handle close to the base and use the other hand to operate the brake pad. Therefore, a whole operation process is relatively troublesome and laborious, and adding the buttons or dial keys also increases the complexity of an overall structure.

### SUMMARY

To overcome a disadvantage of an existing technology, a technical problem to be resolved by the present disclosure is to provide a labor-saving ratchet strap tensioner that has a simple structure, convenient and labor-saving operation, and can ensure continuous and stable braking force.

The technical problem of the present disclosure is overcome by using the following technical solutions:

A labor-saving ratchet strap tensioner is provided, including a base, a base plate in front of the base, a cocking handle, a cocking plate in front of the cocking handle, and a ratchet, where the ratchet includes a ratchet shaft and ratchet discs that are coaxially fastened to two ends of the ratchet shaft, and further including a fastening strap connected to the base, and a tensioning strap with one end wound around the ratchet shaft and the other end being a free binding end. The cocking handle is hingedly connected to the base plate of the base by using the cocking plate to form a rotatable connection that is capable of being cocked. The ratchet and a cocking shaft axis of the cocking plate are coaxially and rotatably installed by using the ratchet shaft. A clamping member meshed with or separated from the ratchet disc is disposed in the base, and a coil spring is disposed outside the base. A stopping member meshed with or separated from the ratchet disc is disposed in the cocking handle. A brake pad is further disposed in the base, and elastically presses an outer circumference of the ratchet disc to form braking force. An arc edge is disposed at a bottom portion of the cocking plate. When the stopping member and the clamping member are both separated from the ratchet disc, the free binding end is pulled outward, to drive the ratchet to overcome the braking force to form a reverse rotation and to quickly release the tensioning strap, and the reverse rotation of the ratchet also synchronously drives the coil spring to compress and to accumulate potential energy. The cocking handle is cocked close to the base and drives the arc edge to slide to push the brake pad, thereby adjusting the braking force. When the braking force is greater than the potential energy, the brake pad limits the coil spring from driving the ratchet to automatically rotate forward. When the braking force is less than the potential energy, the coil spring releases potential energy and drives the ratchet to automatically rotate forward, thereby quickly winding the tensioning strap onto the ratchet shaft.

The stopping member and the clamping member are both meshed with the ratchet disc, and the cocking handle is reciprocatively cocked relative to the base, and drives the ratchet to overcome the braking force to form a one-way intermittent forward rotation, thereby pulling the tensioning strap to be wound around the ratchet shaft.

A push protrusion is disposed at a front portion of the cocking plate, and the cocking handle is cocked close to the base, and drives the push protrusion to push the clamping member to separate from the ratchet disc.

The stopping member is pivotally installed in the cocking handle and forms a seesaw-type rotation structure, and a rear end of the stopping member is elastically pushed to ascend to drive a front end of the stopping member to descend, or the rear end of the stopping member is pressed to descend to drive a front end of the stopping member to ascend.

A strap winding arc groove is provided at a top portion of the base plate, and an arc-shaped groove bottom of the strap winding arc groove is higher than an outer circumference of the ratchet disc. A positioning plate is disposed on the stopping member, and the positioning plate is fitted in the strap winding arc groove, to enable the stopping member to separate from the ratchet disc.

A working arc groove is provided at the top portion of the base plate, the working arc groove is located on a front side of the strap winding arc groove, and an arc-shaped groove bottom of the working arc groove is lower than the outer circumference of the ratchet disc. The positioning plate is fitted in the working arc groove, so that the stopping member is meshed with the ratchet disc. The cocking handle is reciprocatively cocked relative to the base, and drives the positioning plate to slide reciprocatively in the working arc groove, to form a cocking stroke.

A positioning groove is provided at a top portion of the cocking plate, and a groove bottom of the positioning groove is lower than the outer circumference of the ratchet disc. The positioning plate is fitted in the positioning groove.

A stopper is disposed between the working arc groove and the strap winding arc groove. The stopping member is separated from the ratchet disc, and the cocking handle is cocked close to the base, and drives the positioning plate to pass from the working arc groove over the stopper into the strap winding arc groove.

A lower end of the brake pad is hingedly connected into the base, a braking protrusion is disposed at an upper end of the brake pad, and the braking protrusion is elastically pushed to press against an outer circumference of the ratchet disc to form the braking force.

The stopping member includes a stopping plate and a key fastened on a rear side of the stopping plate, the positioning plate is disposed on each of two sides of a front portion of the stopping plate, a support plate is disposed on each of two sides of a front portion of the stopping plate, and the stopping member is pivotally installed in the cocking handle by using the support plate.

Compared with the existing technology, in the present disclosure, the brake pad is mainly disposed in the base, and elastically presses the ratchet disc of the ratchet to form the braking force. The arc edge is disposed at the bottom portion of the cocking plate. In this way, when the stopping member and the clamping member are both separated from the ratchet disc, the free binding end is pulled outward, so that the ratchet can be driven to overcome the braking force to form a reverse rotation and to quickly release the tensioning strap, and the reverse rotation of the ratchet also synchronously drives the coil spring to compress and to accumulate potential energy; and In addition, because the brake pad elastically presses against the outer circumference of the ratchet disc to form the braking force, and a size of the outer circumference of the ratchet disc remains unchanged as the ratchet disc rotates, the tensioning strap is completely pulled out from the ratchet to a longest use position. Even if the potential energy accumulated through compression of the coil spring is up to a maximum, the braking force can always be ensured to be continuous and stable. Then the cocking handle is cocked close to the base, so that the arc edge can be driven to slide to push the brake pad, thereby adjusting the braking force. Usually, when the braking force is greater than the potential energy, the brake pad limits the coil spring from driving the ratchet to automatically rotate forward. When the braking force adjusted through pushing by the arc edge is less than the potential energy, the coil spring releases the potential energy and drives the ratchet to automatically rotate forward, thereby quickly winding the tensioning strap onto the ratchet shaft. Obviously, the foregoing operation structure of the brake pad does not require an additional button or dial key, thereby enabling an overall structure to be simpler. In particular, only one hand is required to cock the cocking handle close to the base, and the brake pad can be pushed through sliding of the arc edge to synchronously adjust the braking force. Therefore, an operation process is quite convenient and labor-saving.

### BRIEF DESCRIPTION OF THE DRAWINGS

FIG. 1 is a main view of the present disclosure.

FIG. 2 is a rear view of FIG. 1.

FIG. 3 is a top view of FIG. 1.

FIG. 4 is a three-dimensional view of FIG. 1.

FIG. 5 is a three-dimensional exploded view of FIG. 4.

FIG. 6 is a schematic structural diagram of a base.

FIG. 7 is a three-dimensional view of FIG. 6.

FIG. 8 is a schematic structural diagram of a cocking handle.

FIG. 9 is a three-dimensional view of FIG. 8.

FIG. 10 is a schematic structural diagram of a stopping member.

FIG. 11 is a three-dimensional view of FIG. 10.

FIG. 12 is a schematic structural diagram of a brake pad.

FIG. 13 is a schematic structural diagram of a ratchet.

FIG. 14 is a schematic structural diagram of a core shaft.

FIG. 15 is a schematic structural diagram of a jacket.

### DETAILED DESCRIPTION

The following further describes the embodiments of the present disclosure in detail according to the foregoing accompanying drawings.

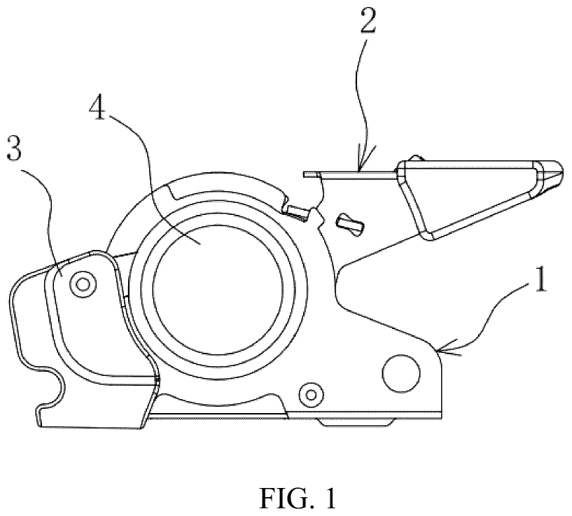

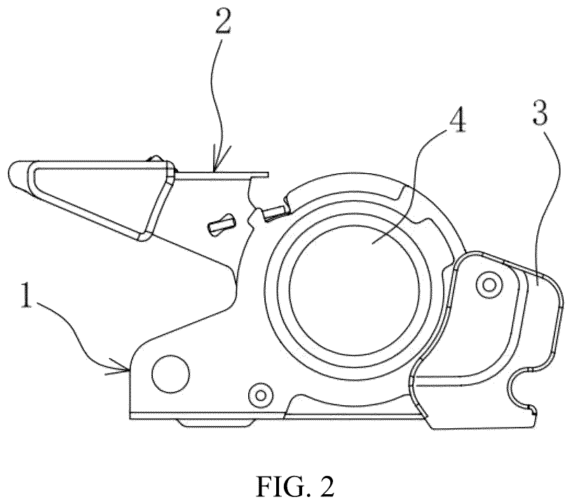

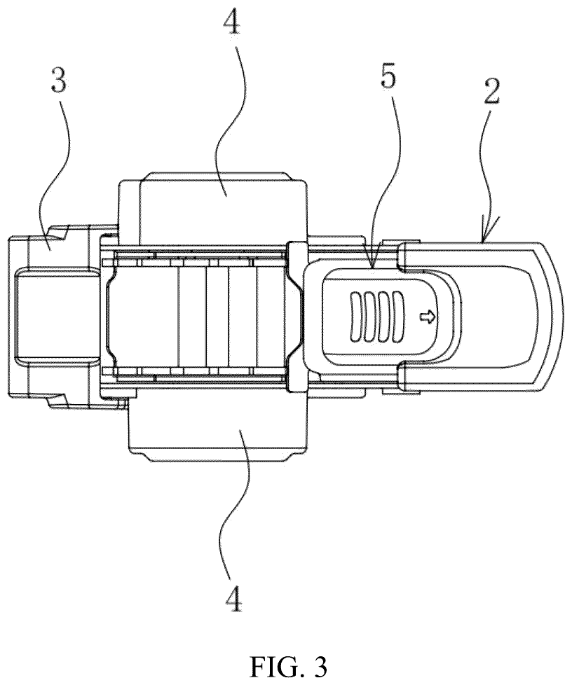

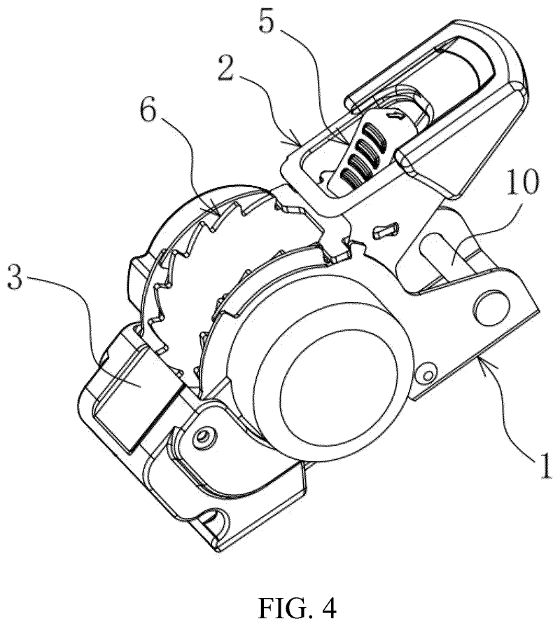

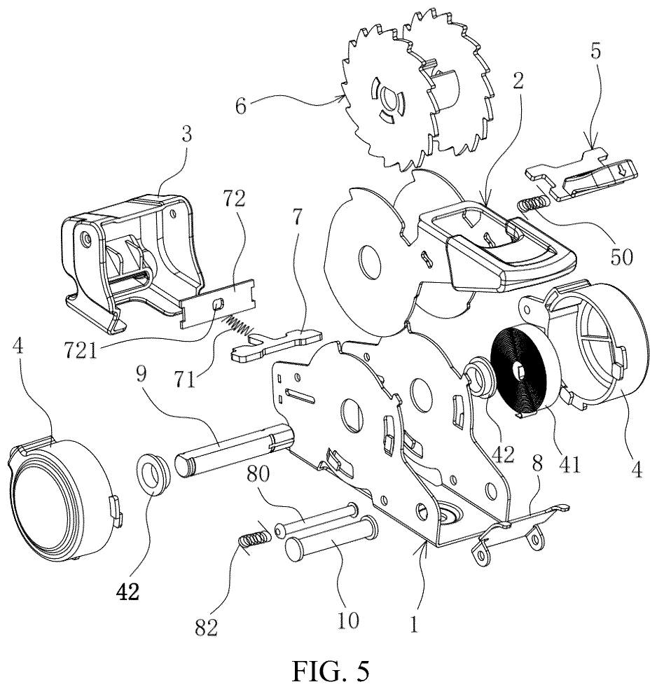

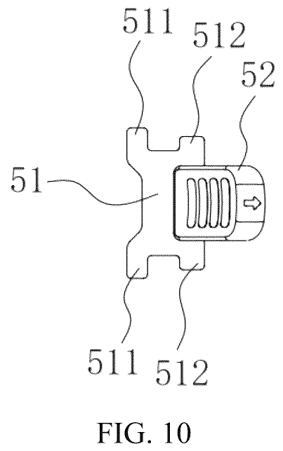

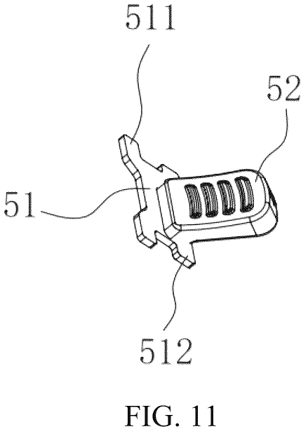

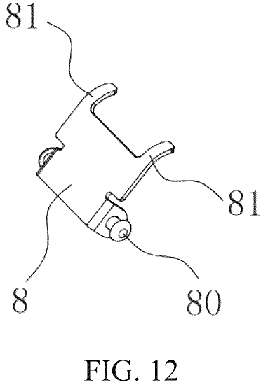

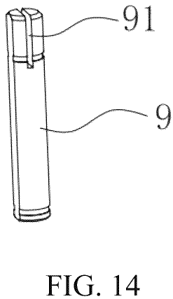

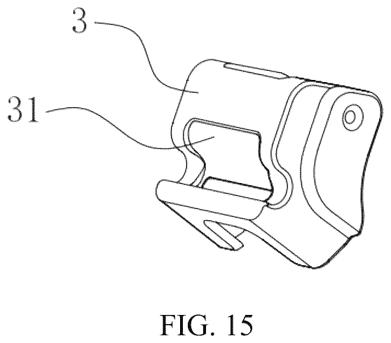

As shown in FIG. 1 to FIGS. 15, 1. base, 10. fastening rod, 11. base plate, 111. working arc groove, 112. strap winding arc groove, 113. stopper, 114. sliding groove, 2. cocking handle, 21. cocking plate, 211. cucurbit hole, 212. push protrusion, 213. arc edge, 214. positioning groove, 22. protective handle, 3. jacket, 31. strap threading hole, 4. side cover, 41. coil spring, 42. protective ring, 5. stopping member, 50. stopping member torsion spring, 51. stopping plate, 511. positioning plate, 512. support plate, 52. key, 6. ratchet, 61. ratchet shaft, 62. ratchet disc, 7. clamping member, 71. clamping member spring, 72. clamping member plate, 721. guide hole, 8. brake pad, 80. brake pad shaft, 81. braking protrusion, 82. brake pad torsion spring, 9. core shaft, 91. clamping groove.

A labor-saving ratchet strap tensioner is shown in FIG. 1 to FIG. 5, and is mainly used for assisting in binding and tightening goods. A structure of the ratchet strap tensioner includes a base 1, a base plate 11 in front of the base, a cocking handle 2, a cocking plate 21 in front of the cocking handle, and a ratchet 6. The ratchet includes a ratchet shaft 61 and ratchet discs 62 that are coaxially fastened to two ends of the ratchet shaft. The structure further includes a fastening strap (not shown in the figure) connected to the base 1, and a tensioning strap (not shown in the figure) with one end wound around the ratchet shaft 61 and the other end being a free binding end. In this embodiment, a left side of a view shown in FIG. 1 is used as a front portion or front side of the ratchet strap tensioner, and a right side of the view is used as a rear portion or rear side of the ratchet strap tensioner.

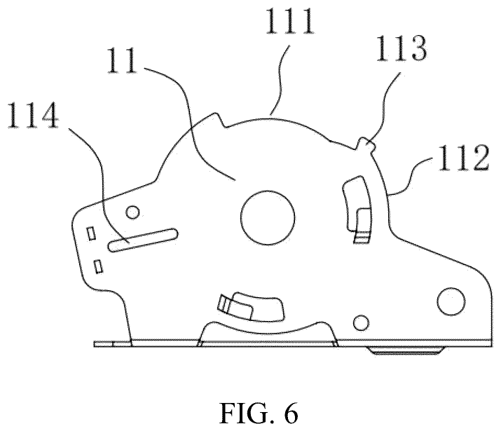

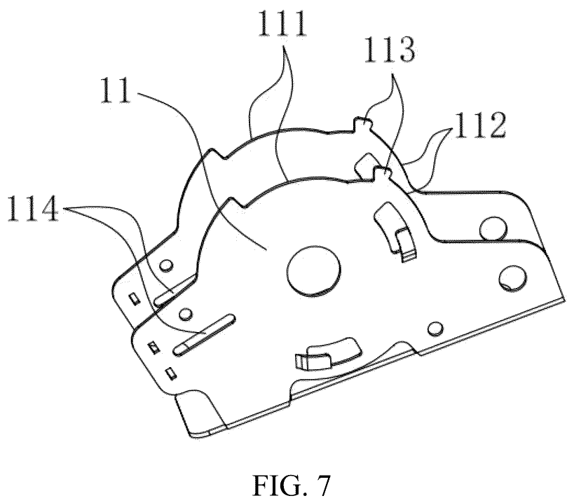

As shown in FIG. 6 and FIG. 7, the base 1 is a structural component that has a “U”-shaped cross section and that is jointly formed by a bottom plate and two side plates that are located on two sides of the bottom plate and bent vertically upward. A base plate 11 is disposed at each of front ends of the two side plates, that is, the base plate is located at a front portion of the base. A shaft hole is provided at a center of each base plate. Shaft holes of two base plates 11 are exactly located on a same horizontal shaft axis.

A plastic jacket 3 is disposed at a front portion of the base, to protect the base plate 11. A strap threading hole 31 is provided in the jacket, to allow a free binding end of a tensioning strap to exit.

A “T”-shaped clamping member 7 is further disposed at a front portion of the base. Specifically, the clamping member is disposed in the base 1 and is located on a front side of the ratchet 6. Two ends of “T” of the clamping member 7 are respectively fitted in sliding grooves 114 of the base plates 11 on two sides. A clamping member spring 71 for elastically pushing is disposed at a tail end of the “T” of the clamping member 7. That is, two ends of the clamping member spring are respectively installed, in a pushing manner, on the clamping member 7 and a clamping member plate 72 located in the jacket 3. Therefore, normally, the clamping member 7 is elastically pushed by the clamping member spring 71 to be meshed with the ratchet disc 62 all along. The clamping member 7 can be separated from the ratchet disc 62 only when the clamping member 7 is driven by external force to slide along the sliding groove 114 against elastic pushing force of the clamping member spring 71. Therefore, an action status of the clamping member 7 needs to be engaged with or separated from the ratchet disc 62 based on an actual working situation. A guide hole 721 is further provided on the clamping member plate 72, and may be used for ensuring action stability of the clamping member 7.

A fastening rod 10 is disposed at a rear portion of the base 1 and may be used for connecting to a fastening strap. A brake pad 8 is disposed on a front side of the fastening rod 10. A lower end of the brake pad 8 is hingedly connected in the base 1 by using a brake pad shaft 80. Therefore, an upper end of the brake pad 8 may rotate around the brake pad shaft 80, to move close to or away from the ratchet 6. A braking protrusion 81 is disposed at the upper end of the brake pad, and is elastically pushed by a brake pad torsion spring 82 installed on the brake pad shaft 80, to press against an outer circumference of the ratchet disc 62 to generate braking force.

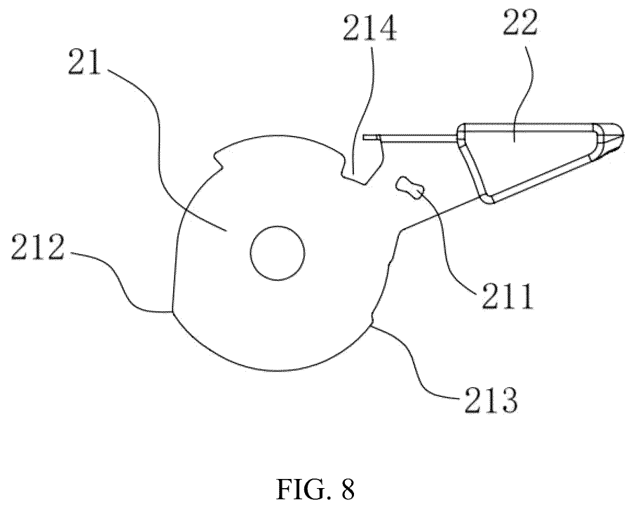

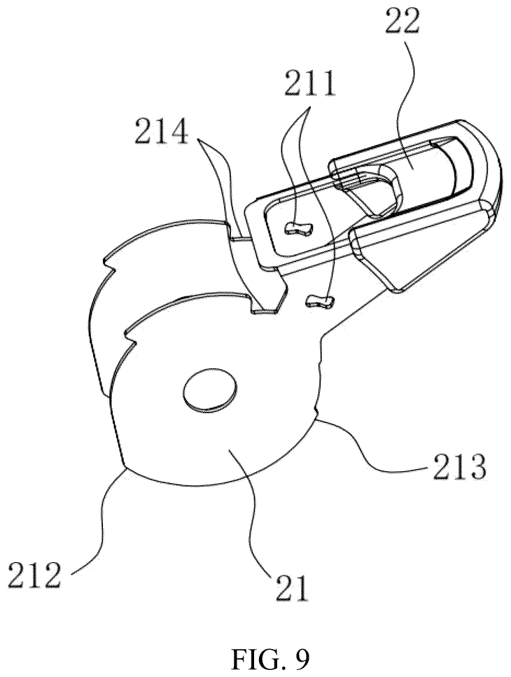

As shown in FIG. 8 and FIG. 9, the cocking handle 2 is a structural component that has an inverted-“U”-shaped cross section and that is jointly formed by a top plate and two side plates that are located on two sides of the top plate and bent vertically downward. A cocking plate 21 is disposed at each of front ends of the two side plates, that is, the cocking plate is located at a front portion of the cocking handle. A shaft hole is provided at a center of each cocking plate 21. Shaft holes of two cocking plates are also exactly located on a same horizontal shaft axis.

In this way, the cocking handle 2 may be hingedly connected to the base plate 11 of the base 1 by using the cocking plate 21 through the shaft hole, so that a rotation connection structure that is capable of being cocked and that is of the cocking handle 2 relative to the base 1 can be formed.

A plastic protective handle 22 is disposed at a rear portion of the cocking handle 2, so that a user can hold and operate the cocking handle 2 comfortably. A stopping member 5 pivotally installed and forming a seesaw-type rotation structure is disposed in the cocking handle 2. The stopping member includes a stopping plate 51 and a key 52 fastened on a rear side of the stopping plate.

A positioning plate 511 is disposed on each of two sides of a front portion of the stopping plate 51, and a support plate 512 is disposed on each of two sides of a rear portion of the stopping plate. Therefore, the positioning plate 511 and the supporting plate 512 are combined to enable the entire stopping plate 51 to form an “H”-shaped component. The stopping member 5 is pivotally installed in the cocking handle 2 by using the support plate 512. Specifically, support plates 512 on the two sides are respectively fitted in cucurbit holes 211 on two sides of the cocking handle 2, thereby forming a seesaw-type structure that can swing back and forth.

In addition, under normal circumstances, a rear end of the stopping member 5 is elastically pushed by a stopping member torsion spring 50 installed in the cocking handle 2 to ascend, to drive a front end of the stopping member to descend. In this case, the descending front end of the stopping member is usually meshed with the ratchet disc 62, or torsion spring force may be overcome by pressing the key 52 with external force, so that the rear end of the stopping member can be enabled to descend to drive the front end of the stopping member to ascend. In this case, the ascending front end of the stopping member is usually separated from the ratchet disc 62. Therefore, an action status of the stopping member 5 also needs to be meshed with or separated from the ratchet disc 62 based on an actual working situation. An anti-slip pattern and a pressing indication arrow are usually designed on the key 52, to facilitate easy operations of a user.

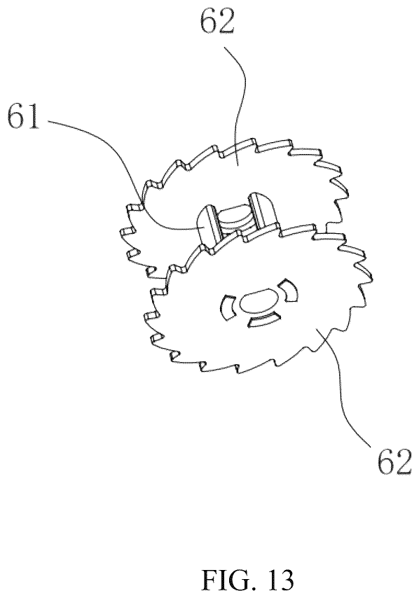

As shown in FIG. 13, a connection groove for insertion, a connection, and winding of one end of the tensioning strap is disposed on the ratchet shaft 61 of the ratchet 6. Ratchet teeth inclined in a same circumferential direction are disposed on outer circumferences of the ratchet discs 62 at two ends. For example, as shown in FIG. 1, the ratchet teeth are all inclined in a clockwise direction.

The ratchet 6 and a cocking shaft axis of the cocking plate 21 are coaxially and rotatably installed by using the ratchet shaft 61. Specifically, the ratchet shaft 61 is set to a hollow flat hole shaft, a core shaft 9 passes through the ratchet shaft, and the core shaft is a solid flat shaft fitted with a flat hole. Therefore, the core shaft 9 and the ratchet 6 can form a synchronous rotation. Two ends of the core shaft 9 are respectively inserted into the shaft holes of the base plate 11 and the cocking plate 21, and rotation support and position locking are formed by using a protective ring 42. Therefore, the ratchet 6 rotates through the core shaft 9, and the rotation shaft axis of the ratchet just overlaps with a cocking shaft axis of the cocking handle 2.

Side covers 4 for snap-fitting and fastening are respectively disposed on two sides of the base 1, to close two ends of the core shaft 9, to make an overall appearance beautiful. In addition, a coil spring 41 needs to be disposed in one of the side covers 4. An inner end of the coil spring is clamped in a clamping groove 91 at an end portion of the core shaft 9 to form a connection. An outer end of the coil spring 41 is tightly installed in the side cover 4. Therefore, when the ratchet 6 drives the core shaft 9 to rotate, the coil spring 41 is also driven to synchronously compress, to accumulate potential energy. Alternatively, the coil spring 41 releases potential energy to drive the core shaft 9 to rotate, to further drive the ratchet 6 to synchronously rotate.

In addition, a working arc groove 111 and a strap winding arc groove 112 are provided at a top portion of the base plate 11. The working arc groove is located on a front side of the strap winding arc groove, and a stopper 113 is disposed between the working arc groove 111 and the strap winding arc groove 112. An arc-shaped groove bottom of the working arc groove 111 is lower than the outer circumference of the ratchet disc 62, and an arc-shaped groove bottom of the strap winding arc groove 112 is higher than the outer circumference of the ratchet disc 62. In addition, as shown in FIG. 7, the working arc groove 111, the strap winding arc groove 112, and the stopper 113 are disposed at the top potion of each of the base plates 11 on the two sides. It further needs to be ensured that positions of these design structures on the base plates 11 on the two sides are symmetrically consistent and have completely a same size.

A positioning groove 214 is disposed at a top portion of the cocking plate 21. A bottom of the positioning groove is lower than the outer circumference of the ratchet disc 62, and the positioning plate 511 of the stopping member 5 may be fitted in the positioning groove 214. An arc edge 213 is disposed at a bottom portion of the cocking plate 21. A push protrusion 212 similar to a cam shape is disposed at a front portion of the cocking plate 21. In addition, as shown in FIG. 9, positions of these structures designed on the cocking plates 21 on the two sides are all symmetrically consistent and in a same size.

In this way, as can be learned based on the foregoing structure, the ratchet strap tensioner has three working states:

A first state is a normal cocking state, and is specifically as follows: The rear end of the stopping member in the cocking handle 2 is driven and elastically pushed by the stopping member torsion spring 50 to ascend, to drive the front end of the stopping member to descend, and the descending front end of the stopping member is simultaneously fitted in the positioning groove 214 and the working arc groove 111. Because the bottoms of the positioning groove 214 and the working arc groove 111 are both lower than the outer circumference of the ratchet disc 62, the front end of the stopping member is also meshed with the ratchet teeth on the ratchet disc 62. In this case, the clamping member 7 is also pushed by the clamping member spring 71 to be meshed with the ratchet teeth on the ratchet disc 62, and the braking protrusion 81 at the upper end of the brake pad 8 also elastically presses against the outer circumference of the ratchet disc 62 by using the brake pad torsion spring 80. Therefore, because the stopping member 5 and the clamping member 7 are both meshed with the ratchet disc 62, as long as the cocking handle 2 is reciprocatively cocked relative to the base 1, the stopping member 5 and the clamping member 7 are driven to be alternately meshed with the ratchet disc 62, thereby driving the ratchet 6 to overcome the braking force to form a one-way intermittent forward rotation, that is, a counterclockwise rotation shown in FIG. 1. The tensioning strap is pulled to be wound around the ratchet shaft 61 layer by layer, thereby achieving binding and tightening of goods.

Moreover, the cocking handle 2 is reciprocatively cocked relative to the base 1, to drive the positioning plate 511 to reciprocatively slide in the working arc groove 111, thereby forming a cocking stroke of the cocking handle 2, that is, forward and backward cocking angles of the cocking handle 2 can be limited by the stroke.

A second state is a quick unwinding state, and is specifically as follows: The key 52 at the rear end of the stopping member is pressed to overcome a decrease in the torsion spring force, so that the front end of the stopping member can be driven to ascend to be separated from the positioning groove 214, the working arc groove 111, and the ratchet teeth of the ratchet disc 62. In this case, the cocking handle 2 is cocked close to the base 1, to drive the positioning plate 511 to pass from the working arc groove 111 over the stopper 113 into the strap winding arc groove 112. Since the bottom of the wound strap arc groove is higher than the outer circumference of the ratchet disc 62, the positioning plate 511 is fitted in the wound strap arc groove 112 to ensure that after pressing force on the key 52 disappears, the front end of the stopping member is not meshed with the ratchet disc 62 again. In this case, the push protrusion 212 is also driven by a rotation of the cocking member 21 to push the clamping member 7 and to enable the clamping member to be separated from the ratchet disc 62 synchronously. Therefore, since the stopping member 5 and the clamping member 7 are both separated from the ratchet disc 62, the ratchet 6 is in an unconstrained state, and as long as the free binding end is pulled outward, the ratchet 6 is driven to overcome the braking force to form a reverse rotation, that is, to rotate clockwise to unwind the strap as shown in FIG. 1, thereby quickly releasing the tensioning strap. The reverse rotation of the ratchet also synchronously drives the coil spring to compress and to accumulate potential energy.

A third state is a quick strap winding state, and is specifically: In a state that the ratchet 6 releases the tensioning strap, the cocking handle 2 is continuously cocked close to the base 1, to drive the arc edge 212 to slide to push the brake pad 8, thereby adjusting the braking force. When the braking force is greater than the potential energy, the brake pad 8 still limits the coil spring 41 from driving the ratchet 6 to automatically rotate forward. Only when the braking force is adjusted to be less than the potential energy, the coil spring 41 releases the potential energy and drives the ratchet 6 to automatically rotate forward, thereby quickly winding the tensioning strap onto the ratchet shaft 61.

Apparently, in the present disclosure, because the brake pad 8 elastically presses against the outer circumference of the ratchet disc 62 to form the braking force, and a size of the outer circumference of the ratchet disc remains unchanged as the ratchet disc rotates, the tensioning strap 6 is completely pulled out from the ratchet 6 to a longest use position. Even if the potential energy accumulated through compression of the coil spring 41 is up to a maximum, the braking force can always be ensured to be continuous and stable.

Especially, the foregoing operation structure of the brake pad 8 does not require an additional button or dial key, thereby enabling an overall structure simpler. Only one hand is required to cock the cocking handle 2 close to the base 1, and the brake pad 8 can be pushed through sliding of the arc edge 212 to synchronously adjust the braking force. Therefore, the operation process is quite convenient and labor-saving.

The basic principle and main features of the present disclosure are described above. Those skilled in the art should understand that the present disclosure is not limited by the above embodiments. Without departing from the spirit and scope of the present disclosure, the present disclosure may have various changes and improvements, which fall within the scope of the present disclosure to be protected. The protection scope of the present disclosure is defined by the attached claims and equivalents thereof.

What is claimed is:

1. A labor-saving ratchet strap tensioner, comprising a base (1), a base plate (11) in front of the base, a cocking handle (2), a cocking plate (21) in front of the cocking handle, and a ratchet (6), wherein the ratchet comprises a ratchet shaft (61) and ratchet discs (62) that are coaxially fastened to two ends of the ratchet shaft, and further comprising a fastening strap connected to the base (1), and a tensioning strap with one end wound around the ratchet shaft (61) and the other end being a free binding end; the cocking handle (2) being hingedly connected to the base plate (11) of the base (1) by using the cocking plate (21) to form a rotatable connection that is capable of being cocked; the ratchet (6) and a cocking shaft axis of the cocking plate (21) being coaxially and rotatably installed by using the ratchet shaft (61); a clamping member (7) meshed with or separated from the ratchet disc (62) being disposed in the base (1), and a coil spring (41) being disposed outside the base (1); and a stopping member (5) meshed with or separated from the ratchet disc (62) being disposed in the cocking handle (2), wherein
a brake pad (8) is further disposed in the base (1), and elastically presses an outer circumference of the ratchet disc (62) to form braking force; an arc edge (213) is disposed at a bottom portion of the cocking plate (21);
when the stopping member (5) and the clamping member (7) are both separated from the ratchet disc (62), the free binding end is pulled outward, to drive the ratchet (6) to overcome the braking force to form a reverse rotation and to quickly release the tensioning strap, and the reverse rotation of the ratchet (6) also synchronously drives the coil spring (41) to compress and to accumulate potential energy; and the cocking handle (2) is cocked close to the base (1) and drives the arc edge (213) to slide to push the brake pad (8), thereby adjusting the braking force; when the braking force is greater than the potential energy, the brake pad (8) limits the coil spring (41) from driving the ratchet (6) to automatically rotate forward; and when the braking force is less than the potential energy, the coil spring (41) releases potential energy and drives the ratchet (6) to automatically rotate forward, thereby quickly winding the tensioning strap onto the ratchet shaft (61).

2. The labor-saving ratchet strap tensioner according to claim 1, where the stopping member (5) and the clamping member (7) are both meshed with the ratchet disc (62), and the cocking handle (2) is reciprocatively cocked relative to the base (1), and drives the ratchet (6) to overcome the braking force to form a one-way intermittent forward rotation, thereby pulling the tensioning strap to be wound around the ratchet shaft (61).

3. The labor-saving ratchet strap tensioner according to claim 1, wherein a push protrusion (212) is disposed at a front portion of the cocking plate (21), and the cocking handle (2) is cocked close to the base (1), and drives the push protrusion (212) to push the clamping member (7) to separate from the ratchet disc (62).

4. The labor-saving ratchet strap tensioner according to claim 1, wherein the stopping member (5) is pivotally installed in the cocking handle (2) and forms a seesaw-type rotation structure, and a rear end of the stopping member is elastically pushed to ascend to drive a front end of the stopping member to descend, or the rear end of the stopping member is pressed to descend to drive a front end of the stopping member to ascend.

5. The labor-saving ratchet strap tensioner according to claim 1, wherein a strap winding arc groove (112) is provided at a top portion of the base plate (11), and an arc-shaped groove bottom of the strap winding arc groove is higher than an outer circumference of the ratchet disc (62); and a positioning plate (511) is disposed on the stopping member (5), and the positioning plate is fitted in the strap winding arc groove (112), to enable the stopping member (5) to separate from the ratchet disc (62).

6. The labor-saving ratchet strap tensioner according to claim 5, wherein a working arc groove (111) is provided at the top portion of the base plate (11), the working arc groove is located on a front side of the strap winding arc groove (112), and an arc-shaped groove bottom of the working arc groove (111) is lower than the outer circumference of the ratchet disc (62); and the positioning plate (511) is fitted in the working arc groove (111), so that the stopping member (5) is meshed with the ratchet disc (62); and the cocking handle (2) is reciprocatively cocked relative to the base (1), and drives the positioning plate (511) to slide reciprocatively in the working arc groove (111), to form a cocking stroke.

7. The labor-saving ratchet strap tensioner according to claim 5, wherein a positioning groove (214) is provided at a top portion of the cocking plate (21), and a groove bottom of the positioning groove is lower than the outer circumference of the ratchet disc (62); and the positioning plate (511) is fitted in the positioning groove (214).

8. The low-power-saving ratchet strap tensioner according to claim 6, wherein a stopper (113) is disposed between the working arc groove (111) and the wound strap arc groove (112);
and the stopping member (5) is separated from the ratchet disc (62), and the cocking handle (2) is cocked close to the base (1), and drives the positioning plate (511) to pass from the working arc groove (111) over the stopper (113) into the strap winding arc groove (112).

9. The labor-saving ratchet strap tensioner according to claim 1, wherein a lower end of the brake pad (8) is hingedly connected into the base (1), a braking protrusion (81) is disposed at an upper end of the brake pad, and the braking protrusion is elastically pushed to press against an outer circumference of the ratchet disc (62) to form the braking force.

10. The low-power-saving ratchet strap tensioner according to claim 9, wherein the stopping member (5) comprises a stopping plate (51) and a key (52) fastened on a rear side of the stopping plate, the positioning plate (511) is disposed on each of two sides of a front portion of the stopping plate (51), a support plate (512) is disposed on each of two sides of a rear portion of the stopping plate (51), and the stopping member (5) is pivotally installed in the cocking handle (2) by using the support plate (512).
